(19) United States
(12) Patent Application Publication
(10) Pub. No.: US 2004/0108915 A1
(43) Pub. Date: Jun. 10, 2004

(54) Non-reciprocal circuit element having small insertion loss and wide isolation bandwidth, and communication device

(75) Inventors: Toshio Takahashi, Niigata-ken (JP); Hitoshi Onishi, Niigata-ken (JP)

Correspondence Address: Brinks Hofer Gilson & Lione, P.O. Box 10395, Chicago, IL, 60610, US

(73) Assignee: Alps Electric Co.

(21) Appl. No.: 10/726,349

(22) Filed: Dec. 2, 2003

(30) Foreign Application Priority Data
Dec. 3, 2002 (JP) 2002-351210

(51) Int. Cl. H01P 1/36

(52) U.S. Cl. 333/24.2; 333/1.1

(57) ABSTRACT

A non-reciprocal circuit element includes a plate-shaped magnetic member; a common electrode arranged on one side of the plate-shaped magnetic member; first, second, and third center conductors which extend in three directions from the outer peripheral portion of the common electrode in such a manner as to surround the plate-shaped magnetic member, which are bent on the other side of the plate-shaped magnetic member, and which intersect one another at predetermined angles on the other side; and a bias magnet arranged in such a manner as to oppose the plate-shaped magnetic member. The conductor width of at least portions of the first and second center conductors is less than 150 μm.

### BACKGROUND OF THE INVENTION

1. Field of the Invention

The present invention relates to a non-reciprocal circuit element and a communication device. More particularly, the present invention relates to a non-reciprocal circuit element having a small insertion loss and a wide isolation bandwidth.

2. Description of the Related Art

A lumped-constant isolator is a high-frequency component having functions for allowing a signal to be passed in the transmission direction without loss and for blocking the passing of a signal in the reverse direction. The lumped-constant isolator is used in such a manner as to be arranged between a transmitting circuit section and an antenna of a mobile communication device, such as a portable phone.

This isolator mainly includes a plate-shaped magnetic member, three center conductors which are wound around the plate-shaped magnetic member, matching capacitors, each being connected to a corresponding conductor, a termination resistor connected to the center conductor for concentration, and a magnet for applying a bias magnetic-field to the plate-shaped magnetic member. There is a tendency for characteristics such as isolation and insertion loss to depend on the conductor width of the center conductor, as described in Japanese Unexamined Patent Application Publication No. 2001-203507.

In Japanese Unexamined Patent Application Publication No. 2001-203507, it is considered that loss can be reduced by making the conductor width of the center conductor to which the termination resistor is connected wider than the conductor width of the other two center conductors. However, as shown in FIG. 5 of the above-described publication, in the conventional isolator, there is a risk that, whereas loss is reduced, the isolation bandwidth becomes much narrower, and when the operating frequency varies, the loss may increase. For this reason, there has heretofore been a demand for an isolator having a low loss and a wide isolation bandwidth.

### SUMMARY OF THE INVENTION

The present invention has been made in view of the above-described circumstances. An object of the present invention is to provide a non-reciprocal circuit element having a small insertion loss and a wide isolation bandwidth and a communication device including this non-reciprocal circuit element.

In order to achieve the above object, in the present invention, the following configurations are employed.

The non-reciprocal circuit element of the present invention includes a plate-shaped magnetic member; a common electrode arranged on one side of the plate-shaped magnetic member; first, second, and third center conductors which extend in three directions from the outer peripheral portion of the common electrode in such a manner as to surround the plate-shaped magnetic member, which are bent on the other side of the plate-shaped magnetic member, and which intersect one another at predetermined angles on the other side; and a bias magnet arranged in such a manner as to oppose the plate-shaped magnetic member, wherein the conductor width of at least portions of the first and second center conductors is less than 150 μm.

According to such a non-reciprocal circuit element, by making the conductor width of at least portions of the first and second center conductors less than 150 μm, the insertion loss can be reduced.

In the non-reciprocal circuit element of the present invention, the conductor width of at least portions of the first and second center conductors is preferably equal to or greater than 90 μm to equal to or smaller than 130 μm.

According to such a non-reciprocal circuit element, by making the conductor width of at least portions of the first and second center conductors to be equal to or greater than 90 μm to equal to or smaller than 130 ρm, the insertion loss can be reduced further.

In the non-reciprocal circuit element of the present invention, the length of the overlapping portions of the two center conductors at the intersection portion of the first and second center conductors is preferably 10% or more of the length of each center conductor on the other side of the plate-shaped magnetic member.

In the non-reciprocal circuit element of the present invention, the greater the length of the overlapping portions of the two center conductors at the intersection portion of the first and second center conductors, the larger the capacitance value which is ensured at the overlapping portions of the first and second center conductors. For this reason, the capacitance value of the capacitor connected to each center conductor becomes smaller, making it possible to expand the isolation bandwidth.

Furthermore, as described above, by making the conductor width of the center conductors less than 150 μm, the reduction in the insertion loss and the expansion of the isolation bandwidth can be achieved at the same time.

In the non-reciprocal circuit element of the present invention, the length of the overlapping portions of the two center conductors at the intersection portion of the first and second center conductors is preferably 20% or more of the length of each center conductor on the other side of the plate-shaped magnetic member.

Similarly to the foregoing, in the non-reciprocal circuit element of the present invention, the greater the length of the overlapping portions of the two center conductors at the intersection portion of the first and second center conductors, the larger the capacitance value which is ensured at the overlapping portions of the first and second center conductors. For this reason, the capacitance value of the capacitor connected to each center conductor becomes smaller, making it possible to further expand the isolation bandwidth.

In the non-reciprocal circuit element of the present invention, the intersection angle at the intersection portion of the first and second center conductors is preferably equal to or less than 30 degrees, and more preferably, equal to or less than 15 degrees.

In the non-reciprocal circuit element of the present invention, the first and second center conductors at the overlapping portions are preferably arranged nearly in parallel, or in addition to portions which are in parallel (parallel portions), non-parallel portions may be present. The greater the length of the parallel portion of the first and second center conductors at the intersection portion of the two center conductors becomes, the more the insertion-loss reduction effect of the non-reciprocal circuit element can be increased.

Furthermore, if there is a non-parallel portion of the first and second center conductors at the intersection portion of the two center conductors, the isolation bandwidth can be expanded further. Therefore, if there is the non-parallel portion in addition to a parallel portion at the intersection portion of the two center conductors, an insertion-loss reduction effect and an improved isolation effect of the non-reciprocal circuit element occur.

In the non-reciprocal circuit element of the present invention, a slit section along the length direction of each center conductor may be provided in the central portion of each of the first and second center conductors in the width direction, and two divided conductors may be provided in each of the center conductors by the slit section.

According to such a non-reciprocal circuit element, since two divided conductors are provided in each center conductor, the inductance of the center conductor can be increased further, the impedance matching of the center conductor can be improved over a wide range, and the insertion loss can be reduced further.

In the non-reciprocal circuit element of the present invention, a matching capacitor may be connected to each of the first and second center conductors, and a matching capacitor and a termination resistor are connected to the third center conductor.

According to such a non-reciprocal circuit element, since a signal is passed from the input side to the output side without loss and the signal is not passed in the reverse direction, the non-reciprocal circuit element is suitable for use in a mobile communication device, such as a portable phone.

The communication device of the present invention includes: a non-reciprocal circuit element as set forth in the foregoing; a transmitting circuit section connected to one of the first and the second center conductors of the non-reciprocal circuit element; and an antenna connected to the other one of the first and second center conductors.

According to such a communication device, since it includes the non-reciprocal circuit element having a small insertion loss and a wide isolation bandwidth, impedance matching can easily be achieved and stable communication can be performed.

### BRIEF DESCRIPTION OF THE DRAWINGS

FIG. 1A is a plan view showing a state in which a portion of an isolator according to a first embodiment of the present invention is removed; and FIG. 1B is a sectional view of the isolator;

FIG. 2 is a plan view showing an example of a magnetic substrate used for the isolator shown in FIG. 1;

FIG. 3 is a development view of an electrode section used for the isolator shown in FIG. 1;

FIG. 4 is a plan view showing a state in which a portion of the isolator according to the first embodiment of the present invention is removed;

FIG. 5A shows an example of an electrical circuit in which this type of isolator is provided; and FIG. 5B shows the operating principle of the isolator;

FIG. 6 shows a second example of the electrode section of the isolator according to the first embodiment of the present invention;

FIG. 7 shows a third example of the electrode section of the isolator according to the first embodiment of the present invention;

FIG. 8 is an exploded perspective view of an isolator according to a second embodiment of the present invention;

FIG. 9 is a plan view showing a state in which a portion of an isolator according to a third embodiment of the present invention is removed;

FIG. 10 is a development view of an electrode section used for the isolator shown in FIG. 9;

FIG. 11 is a graph showing the relationship between insertion loss and the conductor width of a center conductor;

FIG. 12 is a graph showing the dependence of the insertion loss on frequency for the isolator of the first embodiment of the present invention; and

FIG. 13 is a graph showing the dependence of the insertion loss on frequency for the isolator of comparative example 1.

### DESCRIPTION OF THE PREFERRED EMBODIMENTS

The present invention will now be described below in more detail.

(First Embodiment of Non-Reciprocal Circuit Element)

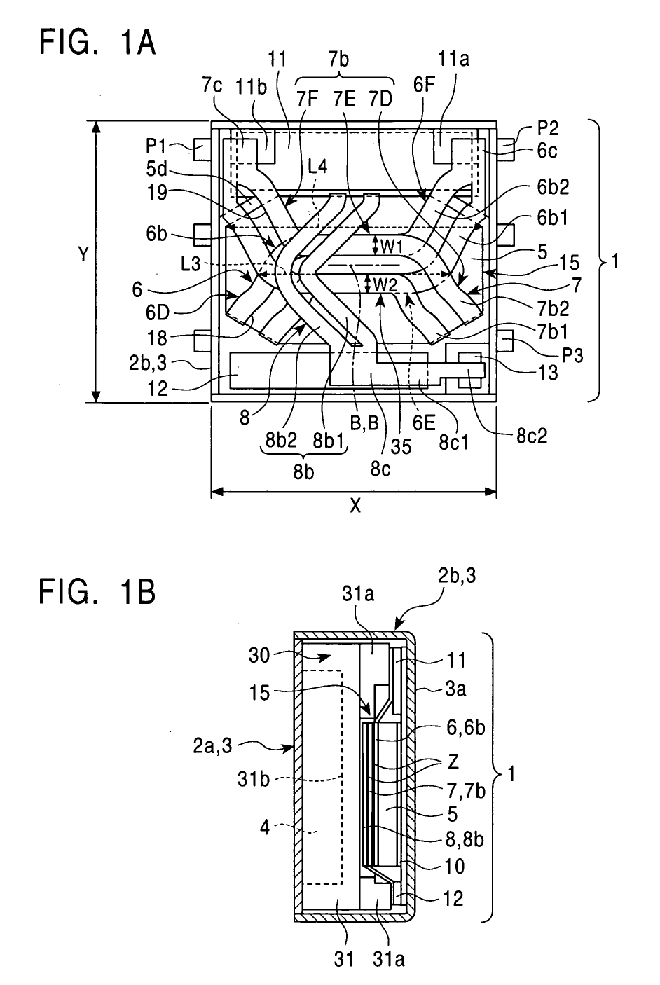

FIGS. 1A, 1B, 2, and 3 show a first embodiment in which a non-reciprocal circuit element according to the present invention is used as an isolator.

An isolator (non-reciprocal circuit element) 1 of this embodiment includes, within a hollow yoke 3 formed of an upper yoke 2a and a lower yoke 2b, a magnet 4 formed of ferrite, etc., a plate-shaped magnetic member 5, line conductor 6, 7, and 8, a common electrode 10 which connect these line conductor 6, 7, and 8, matching capacitors 11 and 12 arranged around the plate-shaped magnetic member 5, and a termination resistor 13.

The upper yoke 2a and the lower yoke 2b are formed of ferromagnetic material, such as soft iron, and these are combined to form the hollow yoke 3 in the shape of a rectangular parallelepiped. Preferably, the obverse and reverse surfaces of the upper and lower yokes 2a and 2b are coated with an Ag-plating conduction layer. The upper yoke 2a, whose side surfaces form the shape of the letter U, has a size which can fit onto the lower yoke 2b, whose side surfaces also form the shape of the letter U, and by fitting the openings of the upper yoke 2a and the lower yoke 2b, the two yokes are combined to form a box-shaped magnetic closed circuit.

The shape of these yokes 2a and 2b is not limited to the shape of the letter U as in this embodiment, and any shape may be used as long as a plurality of yokes form a box-shaped closed magnetic circuit.

In the space defined by the fitted upper and lower yokes 2a and 2b, in other words, in the interior of the hollow yoke 3, a magnetic assembly 15 formed of the above-mentioned plate-shaped magnetic member 5, the three line conductors 6, 7, and 8, and the common electrode 10 which connects the line conductor 6, 7, and 8 is housed. In this manner, the isolator of this embodiment has the magnetic assembly 15.

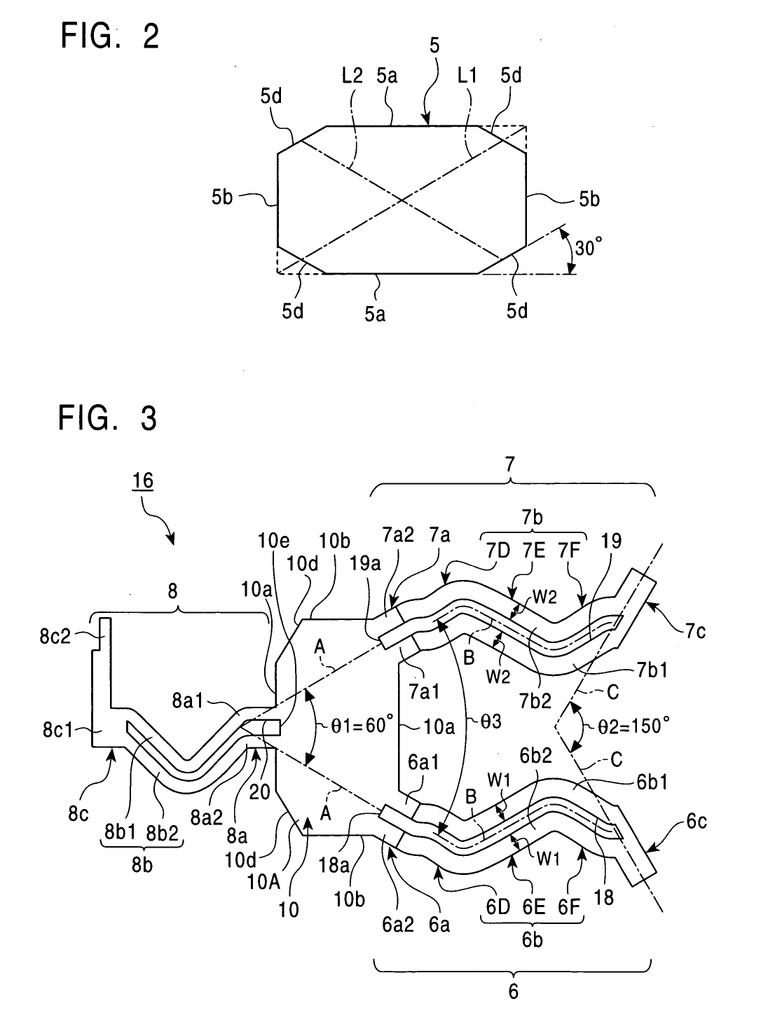

The plate-shaped magnetic member 5 is preferably garnet ferrite having, for example, Y₃Fe₅O₁₂ as a basic constituent. Furthermore, the Y part may be substituted by Gd, and the Fe part may be substituted by In or Al. The plate-shaped magnetic member 5 can take various shapes, such as a circular shape, a rectangular shape, etc., as required. In this embodiment, as shown in FIG. 2, the plate-shaped magnetic member 5 is shaped substantially as a rectangular plate extending horizontally in plan view. More specifically, the plate-shaped magnetic member 5 is shaped substantially as a rectangular plate extending horizontally in plan view, which is formed of two longer sides 5a and 5a opposing each other, which are horizontally rectangular, shorter sides 5b and 5b at right angles to these longer sides 5a and 5a, and four inclined sides 5d which are positioned at the two end portions of the longer sides 5a and 5a, which are inclined at an angle of 150° with respect to each longer side 5a (inclined at an inclination angle of 30° with respect to the extension line of the longer side 5a), and which are connected to the corresponding shorter sides 5b. Therefore, in the four corner portions in plan view of the plate-shaped magnetic member 5, the inclined sides (receiving surfaces) 5d which are inclined at an angle of 150° with respect to each longer side 5a (inclined at an angle of 130° with respect to the shorter sides 5b).

Furthermore, preferably, in this plate-shaped magnetic member 5, the ratio of the width in the horizontal direction thereof, that is, in the longitudinal direction, to the width in the vertical direction, that is, in the direction at right angles to the longitudinal direction, namely, the aspect ratio, is in the range equal to or greater than 25% (1:4) to equal to or smaller than 80% (4:5), that is, it is horizontally rectangular.

Here, although FIG. 1 shows the plate-shaped magnetic member 5 extending horizontally, when viewed from the horizontal direction in which FIG. 1 is rotated 90°, the plate-shaped magnetic member 5 becomes a shape which extends vertically. Therefore, in the present invention, when the plate-shaped magnetic member 5 is either in a shape which extends horizontally or a shape which extends vertically, these cases are considered to be identical.

Next, the above-mentioned three line conductors 6, 7, and 8 and the common electrode 10 are formed integrally, as shown in the development view of FIG. 3, and the three line conductors 6, 7, and 8 and the common electrode 10 mainly form an electrode section 16. This common electrode 10 is formed of a main-unit section 10A made from a metal plate in a shape which is almost the same as the plate-shaped magnetic member 5. That is, the main-unit section 10A is nearly rectangular in plan view, and has two longer-side portions 10a and 10a which oppose each other, two shorter-side portions 10b and 10b at right angles to these longer-side portions 10a and 10a, and inclined sections 10d which are positioned at the two end portions of the longer-side portions 10a and 10a, which are inclined at an angle of 150° with respect to the longer-side portions 10a, and which are connected to the shorter-side portions 10b at an angle of 130°.

Then, the first line conductor 6 and the second line conductor 7 are formed to extend from the common electrode 10. First, the first line conductor 6 formed of a first base conductor 6a, a first center conductor 6b (the center conductor), and a first front-end conductor 6c is formed to extend from one end side of one of the longer-side portions 10a of the common electrode 10, whereas the second line conductor 7 formed of a second base conductor 7a, a second center conductor 7b (the center conductor), and a second front-end conductor 7c is formed to extend from the other end of the longer-side portion 10a.

The angle θ1 formed by the center axes A and A of the base conductors 6a and 7a is approximately 60°, as shown in FIG. 3.

Furthermore, the first center conductor 6b is the center conductor on the input side, and the second center conductor 7b is the center conductor on the output side.

The first center conductor 6b is in a wave shape or in the shape of zigzag in plan view, and is formed of three portions, that is, an end portion 6D of the base on the conductor side, an end portion 6F of the front end on the conductor side, and a central portion 6E. The second center conductor 7b is also shaped similarly to the first center conductor 6b, and is formed of three portions, that is, an end portion 7D of the base on the conductor side, an end portion 7F of the front end on the conductor side, and a central portion 7E. As a result of forming the first and second center conductors 6b and 7b into the shapes such as those described above, the conductor length of each of the center conductors 6b and 7b can be increased to increase the inductance, and thus, both a lower frequency and miniaturized non-reciprocal circuit element can be achieved.

The angle θ3 formed by the center axes of the respective end portions 6D and 7D of the base on the conductor side is approximately the same as the above-mentioned angle θ1 or greater, as shown in FIG. 3; that is, the angle is such that the end portions 6D and 7D of the base on the conductor side become gradually wider toward the outside.

The central portions 6E and 7E are formed in such a manner that, as shown in FIG. 3, the center axes B and B thereof become gradually closer to each other.

The end portions 6F and 7F of the front end on the conductor side are formed such that, as shown in FIG. 3, the angle θ3 formed between the center axes B and B is larger than the angle θ1; that is, the angle is such that the end portions 6F and 7F of the front end on the conductor side become gradually wider toward the outside.

Furthermore, the angle θ2 formed between the center axes C and C of the front-end conductors 6C and 7C is an angle of approximately 150° or more; that is, the angle is such that the end portions 6C and 7C of the front end on the conductor side become gradually wider toward the outside, as shown in FIG. 3.

Next, in the widthwise central portion of the first line conductor 6, a slit section 18 is formed which passes through the base conductor 6a and the center conductor 6b from the outer peripheral portion of the common electrode 10 and which reaches the base end portion of the front-end conductor 6c. As a result of forming this slit section 18, the first center conductor 6b is divided into two divided conductors 6b and 6b2, and the base conductor 6a is also divided into two divided conductors 6a1 and 6a2.

Also, in the central portion of the second line conductor 7 in the width direction, a slit section 19 is formed similarly to the slit section 18. As a result of forming this slit section 19, the second center conductor 7b is divided into two divided conductors 7b1 and 7b2, and the base conductor 7a is also divided into two divided conductors 7a1 and 7a2.

The end portion of the slit section 18 on the common electrode 10 side passes through the connection conductor 6a and reaches a position slightly deeper than the outer peripheral portion of the common electrode 10, thus forming a recessed portion 18a, and the line length of the first line conductor 6 is slightly increased. Also, the end portion of the through slit section 19 on the common electrode 10 side passes through the connection conductor 7a and reaches the outer peripheral portion of the common electrode 10, forming a recessed portion 19a, and the line length of the second line conductor 7 is slightly increased. The recessed portion 18a and the recessed portion 19a may be provided as required, or may not be provided.

As shown in FIGS. 1A and 1B, and 3, the conductor width W1 (the conductor width of the first center conductor) of the divided conductors 6b1 and 6b2 which form the first center conductor is preferably less than 150 μm, and more preferably, in the range equal to or greater than 90 μm to equal to or smaller than 130 μm. Similarly, the conductor width W2 (the conductor width of the second center conductor) of the divided conductors 7b1 and 7b2 which form the second center conductor is preferably less than 150 μm, and more preferably, in the range equal to or greater than 90 to equal to or smaller than 130 μm.

As a result of the conductor width of the first and second center conductors 6b and 7b being set in the above-described range, the insertion loss can be reduced further. If the conductor width of the first and second center conductors 6b and 7b is equal to or greater than 150 μm, the insertion loss increases, which is undesirable. Furthermore, the narrower the conductor width of the center conductors 6b and 7b, the smaller the insertion loss becomes. The narrower conductor width causes the strength of the center conductors 6b and 7b to be decreased, the workability to become poor, and the manufacture of the magnetic assembly 15 to become difficult, which are undesirable. Therefore, from the viewpoint of workability, the limit of the conductor width of the center conductors 6b and 7b is set at 90 μm, but the limit is not limited to this value. If the conductor width can be further reduced as manufacturing technology is improved, the limit can be further reduced.

On the other hand, in the central portion of the common electrode 10 on the other longer-side portion 10a side, a third line conductor 8 is provided so as to extend. This third line conductor 8 includes a third base conductor 8a which protrudes from the common electrode 10, a third center conductor 8b (a center conductor), and a third front-end conductor 8c. The third base conductor 8a is formed of two divided conductors 8a1 and 8a2 in the shape of strips, which extend nearly at right angles from the central portion of the common electrode 10 on the longer side, and a slit 20 is formed between the divided conductors 8a1 and 8a2.

The third center conductor 8b is shaped in such a manner as to be curved in the shape of the letter L in plan view, and is formed of a divided conductor 8b1 in the shape of the letter L in plan view, which is connected to the divided conductor 8a1, and a divided conductor 8b2 in the shape of the letter L in plan view, which is connected to the divided conductor 8a2. As a result of forming the third center conductor 8b in such a manner as to be curved in this manner, the effective conductor length of the line conductor can be increased to increase the inductance, so that both a lower frequency and miniaturized non-reciprocal circuit element can be achieved.

Furthermore, the front-end portions of these divided conductors 8b1 and 8b2 are formed integrally with the third front-end conductor 8c, which is in the shape of the letter L. This third front-end conductor 8c includes a connection section 8c1 which is formed to extend in the same direction as that of the divided conductors 8a1 and 8a2 by integrating the divided conductors 8b1 and 8b2, and a connection section 8c2 which extends nearly at right angles to this connection section 8c1.

Next, on one longer-side portion 10a side of the common electrode 10, in a portion between the divided conductors 8a1 and 8a2 of the third line conductor 8, a recessed portion 10e is formed in such a manner that a portion of the longer-side portion 10a of the common electrode 10 is cut. As a result of forming this recessed portion 10e, the line length of the third line conductor 8 is slightly increased. This recessed portion 10e may also be provided as required, similarly to the recessed portions 18a and 19a.

The electrode section 16 configured as described above, together with the plate-shaped magnetic member 5, forms the magnetic assembly 15 in such a manner that the main-unit section 10A of the common electrode 10 is provided on the rear surface (one side) of the plate-shaped magnetic member 5; and the first line conductor 6, the second line conductor 7, and the third line conductor 8 are bent on the obverse surface of the plate-shaped magnetic member 5 (on the other side) and are attached to the plate-shaped magnetic member 5.

More specifically, the divided conductors 6a1 and 6a2 of the first line conductor 6 are bent along the edge of one inclined surface 5d of the plate-shaped magnetic member, the divided conductors 7a1 and 7a2 of the second line conductor 7 are bent along the edge of the other one inclined surface 5d of the plate-shaped magnetic member 5, the divided conductors 8a1 and 8a2 of the third line conductor 8 is bent along the edge of the of the longer side 5a of the plate-shaped magnetic member 5, the center conductor 6a of the first line conductor 6 is provided along the obverse surface (the other side) of the plate-shaped magnetic member 5, the center conductor 7b of the second line conductor 7 is provided along the obverse surface (the other side) of the plate-shaped magnetic member 5, and the center conductor 8b of the third line conductor 8 is provided along the central portion of the obverse surface of the plate-shaped magnetic member. Thus, the electrode section 16 is attached to the plate-shaped magnetic member 5, forming the magnetic assembly 15.

Since the first and second center conductors 6b and 7b are formed as described above, when these are provided along the obverse surface (the other side) of the plate-shaped magnetic member 5 in the manner described above, the first and second center conductors 6b and 7b intersect on the obverse surface of the plate-shaped magnetic member 5. FIG. 1 shows a case in which the central portions 6E and 7E overlap each other.

The length L3 of the overlapping portions of the two center conductors at the intersection portion 35 of the first and second center conductors 6b and 7b is preferably 10% or more of the length L4 of the overlapping center conductors on the obverse surface (the other side) of the magnetic substrate 5, more preferably, 20% or more. FIG. 1 shows a case in which the length L3 of the overlapping portions of the two center conductors at the intersection portion 35 is about 75% of the length L4 of the overlapping center conductors on the obverse surface of the plate-shaped magnetic member 5.

As the length L3 of the overlapping portions of the first and second center conductors 6b and 7b becomes greater, the capacitance value ensured at such overlapping portions is increased. For this reason, the capacitance value of the capacitor connected to each of the center conductors 6b and 7b becomes smaller, and the isolation bandwidth can be expanded. In particular, by making the conductor width of the center conductors 6b and 7b to be less than 150 μm, reduction in the insertion loss and expansion of the isolation bandwidth can be achieved at the same time.

The upper limit of the length L3 of the overlapping portions of the first and second center conductors 6b and 7b is possible up to 100% of the length L4 of the overlapping center conductors on the surface of the plate-shaped magnetic member 5 by changing the shape of the first and second line conductors 6 and 7, for example, by changing the angle θ1 formed between the center axes A and A of the first and second base conductors 6a and 7a or the angle θ3 formed between the center axes B and B of the first and second center conductors 6b and 7b.

Furthermore, in a case where the overlapping portions of the first and second center conductors 6b and 7b intersect, the intersection angle is preferably equal to or smaller than 30°, and more preferably, equal to or smaller than 15°.

More preferably, the overlapping first and second center conductors 6b and 7b of the first and second center conductors 6b and 7b do not intersect, and are nearly in parallel.

FIG. 1 shows a case in which the center axes B and B of the central portions 6E and 7E are in parallel with each other.

Although not shown in FIG. 1A, insulating sheets Z are interposed between the plate-shaped magnetic member 5, the first line conductor 6, the second line conductor 7, and the third line conductor 8, so that the line conductors 6, 7, and 8 are electrically insulated individually.

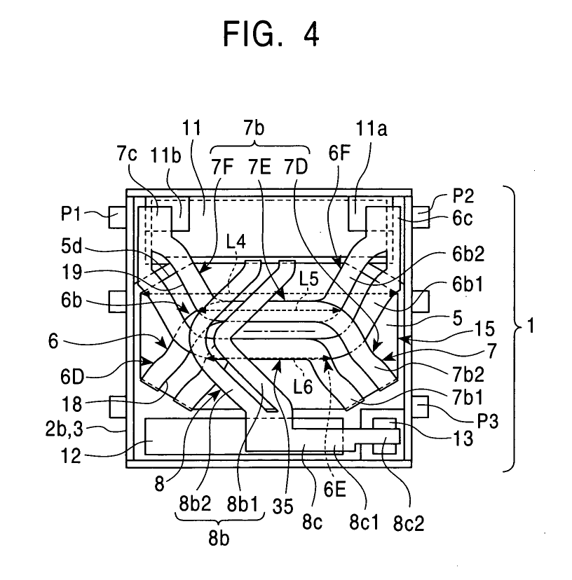

The length of the overlapping portions of the first and second line conductors 6 and 7 at the intersection portion 35 of the first and second center conductors 6b and 7b in a case where the first and second line conductors 6 and 7 are each divided into two divided conductors in the manner described above may be, as shown in FIG. 4, a length L5 of the overlapping portions of the one divided conductors 6b1 of the first center conductor and the one divided conductors 7b1 of the second center conductor or a length L6 of the overlapping portions of the other divided conductor 6b2 of the first center conductor and the other divided conductor 7b2 of second center conductor. In this case, each of the lengths L5 and L6 of the overlapping portions of the two divided conductors is preferably 10% or more of the length L4 of the overlapping center conductor portions on the obverse surface (the other surface) of the plate-shaped magnetic member 5 for the above-described reasons.

The intersection angle of the overlapping portions of the two center conductors at the intersection portion 35 of the first and second line conductors 6 and 7 in a case where the first and second center conductors 6b and 7b are each divided into two divided conductors in the manner described above may be the intersection angle of the overlapping portions of the one divided conductors 6b1 of the first center conductor and the one divided conductors 7b1 of the second center conductor, and may be the intersection angle of the overlapping portions of the other divided conductor 6b2 of the first center conductor and the other divided conductors 7b2 of the second center conductor. The intersection angle in this case is preferably 30° or less for the above-described reasons.

Next, the magnetic assembly 15 is placed in the central portion of the bottom of the lower yoke 2b. The plate-shaped matching capacitors 11 and 12, which are elongated in plan view, having a thickness of approximately half of that of the plate-shaped magnetic member 5, are housed at portions on both sides of the magnetic assembly 15 on the bottom of the lower yoke 2b. The termination resistor 13 is housed on one side of the matching capacitor 12.

Then, the front-end conductor 6c of the first line conductor 6 is electrically connected to the electrode section 11a formed at the end portion on one side of the matching capacitor 11. The front-end conductor 7c of the second line conductor 7 is electrically connected to the electrode section 11b formed at the end portion on the other side of the matching capacitor 11. The front-end conductor 8c of the third line conductor 8 is electrically connected to the matching capacitor 12 and the termination resistor 13. The matching capacitors 11 and 12 and the termination resistor 13 are connected to the magnetic assembly 15. If the termination resistor 13 is not connected, the isolator functions as a circulator.

At the end portion of the matching capacitor 11 to which a portion of the front-end conductor 7c is connected, a first port P1 of the non-reciprocal circuit element 1 is formed. At the end portion of the matching capacitor 11 to which a portion of the front-end conductor 6c is connected, a second port P2 of the non-reciprocal circuit element 1 is formed. The end portion of the termination resistor 13 to which a portion of the front-end conductor 8c is connected is formed as a third port P3 of the isolator 1.

In the space between the lower yoke 2b and the upper yoke 2a, the magnetic assembly 15 is formed into a thickness which occupies approximately half of the thickness of the space. In the space which is nearer the upper yoke 2a than the magnetic assembly 15, a spacer member 30 is housed, and a magnet member 4 is disposed in the spacer member 30.

The spacer member 30 is formed of a base plate section 31 in the shape of a rectangular plate in plan view at a size which can be housed inside the upper yoke 2a, and foot sections 31a formed at the four corner portions on the bottom of the base plate section 31. On the surface (the top surface) on the side where the foot sections 31a . . . are not formed in the base plate section 31, a circular recessed portion 31b is formed, and a through hole (not shown) which goes through the base plate section 31 is formed on the bottom of the recessed portion 31b.

The magnet 4 in the shape of a disk is fitted into the housing recessed portion 31b. The four foot sections 30a of the spacer member 30 provided with the magnet 4 presses the matching capacitors 11 and 12, the first front-end conductors 6c and 7c connected to the matching capacitors 11 and 12, the termination resistor 13, and the front-end portion of the front-end conductor 8c connected to the termination resistor 13 against the bottom side of the lower yoke 2b, and in a state in which the bottom of the spacer member 30 presses the magnetic assembly 15 against the bottom of the lower yoke 2b, the isolator is housed between the yokes 2a and 2b.

According to the above-described isolator 1, the conductor width of the first and second center conductors 6b and 7b is less than 150 μm, and more preferably, it is equal to or greater than 90 μm to equal to or smaller than 130 μm, and the length L3 of the overlapping portions of the first and second center conductors 6b and 7b at the intersection portion 35 of the two center conductors is made to be 10% or more of the length L4 of each center conductor at the other side of the plate-shaped magnetic member. As a result, reduction in the insertion loss and expansion of the isolation bandwidth can be achieved at the same time.

Since each of the first line conductor 6 and the second line conductor 7 is folded on the obverse surface of the plate-shaped magnetic member 5, it is possible to effectively propagate the signal which is input from the line conductor on the input side to the plate-shaped magnetic member 5 on the output side, and passing characteristics with a low loss and a wide bandwidth can be obtained. Therefore, suitable magnetic characteristics of the magnetic assembly 15 can be obtained reliably.

In a case where the isolator 1 of this embodiment is provided in a portable phone which is used at a comparatively low frequency of approximately 0.8 to 0.9 GHz, it is necessary to make the inductance large. In this embodiment, by forming a slit section in each line conductor, the line conductor is divided into two divided conductors, and thus, mutual inductance is generated. Therefore, even at the same conductor length of the line conductor, the divided configuration makes it possible to obtain a large inductance. Furthermore, by forming a recessed portion at the end portion of each slit section on the common electrode 10 side, the line length of the line conductor is slightly increased, thereby obtaining a large inductance.

In the manner described above, in the isolator 1 which is used at a comparatively low frequency of approximately 0.8 to 0.9 GHz, a capacitor with a large capacitance value becomes necessary. Since the magnetic assembly 15 such as that described above is provided, the capacitance value which is ensured at the overlapping portions of the first and second center conductors 6b and 7b at the intersection portion 35 becomes larger, and the capacitance value of the capacitor connected to each line conductor can be decreased correspondingly. As a result of being capable of decreasing the occupied area of the capacitor substrate connected to the line conductor if the same inductance is to be ensured, a miniaturized isolator can be formed.

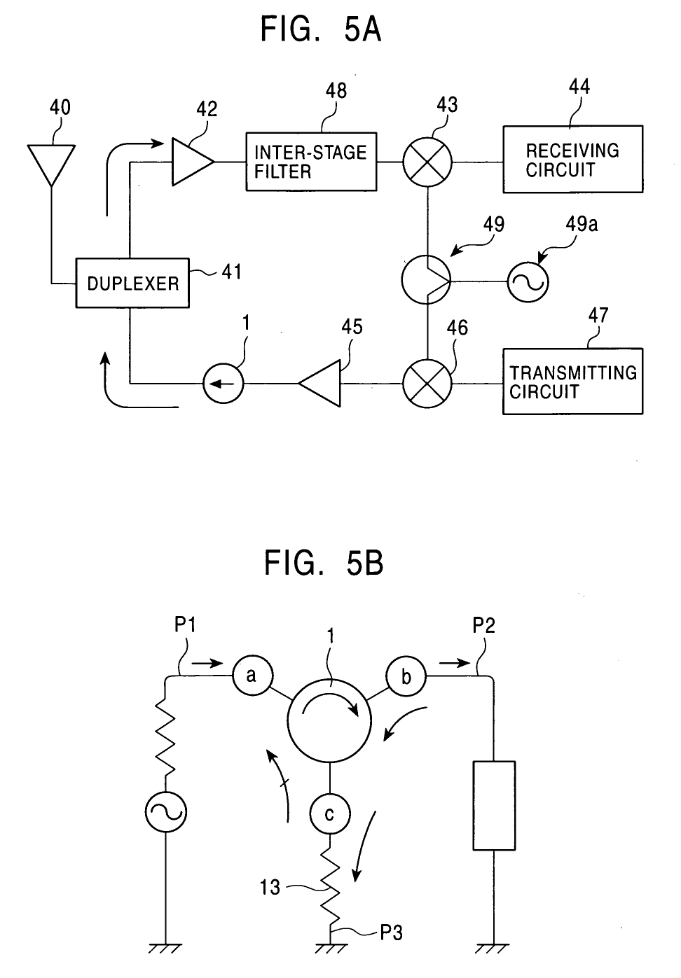

FIG. 5B shows the operating principle of the isolator 1 having the configuration shown in FIGS. 1A to 4. The isolator 1 incorporated in the circuit shown in FIG. 5B causes a signal in the direction from the first port P1 indicated at numeral (1) to the second port P2 indicated at numeral (2), but causes the termination resistor 13 to absorb a signal from the second port P2 of numeral (2) to the termination resistor 13 of numeral (3), and blocks a signal from the third port P3 indicated at numeral (3) on the termination resistor 13 side.

Therefore, when the isolator 1 is incorporated in the circuit shown in FIG. 5A, the above-described advantages can be obtained.

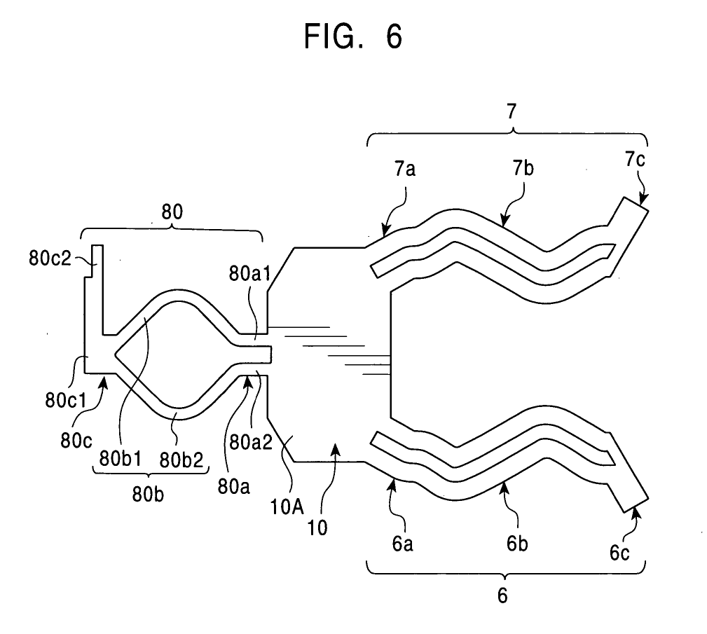

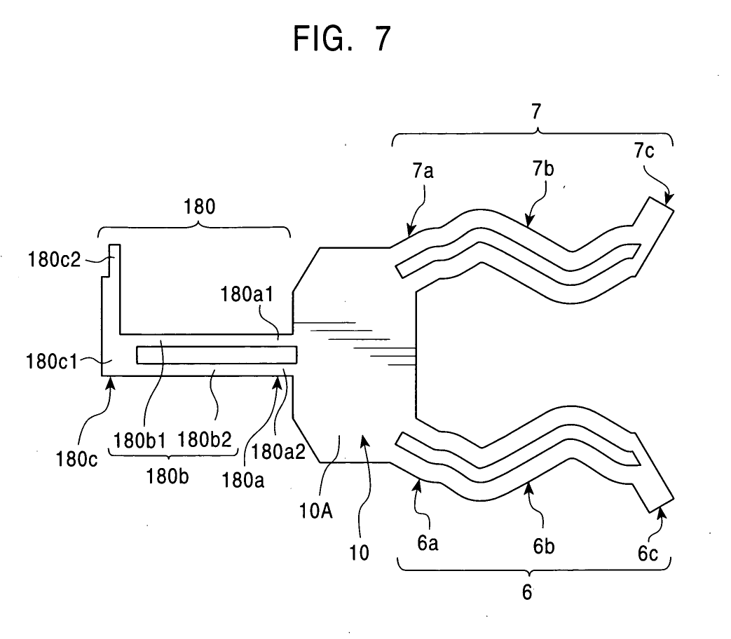

In the isolator of the above-described embodiment, although a case is described in which the third line conductor 8 of the electrode section 16 provided in the magnetic assembly 15 has a shape shown in FIG. 3, it may have a shape shown in FIG. 6 or 7.

The difference of a third line conductor 80 of FIG. 6 from the third line conductor 8 of FIG. 3 is that divided conductors 80a1 and 80a2 are not in parallel, more specifically, extend from the divided conductors 80a1 and 80a2 in such a manner that their central portions are spaced apart, and a rhombic center conductor 80b is formed from divided conductors 80b1 and 80b2.

The difference of a third line conductor 180 of FIG. 7 from the third line conductor 8 of FIG. 3 is that divided conductors 180a1 and 180a2 are in the shape of lines in plan view, and a center conductor 180b is formed of divided conductors 180b1 and 180b2. In this case, the bending of the third line conductor 180 onto the plate-shaped magnetic member 5 becomes easier.

(Second Embodiment)

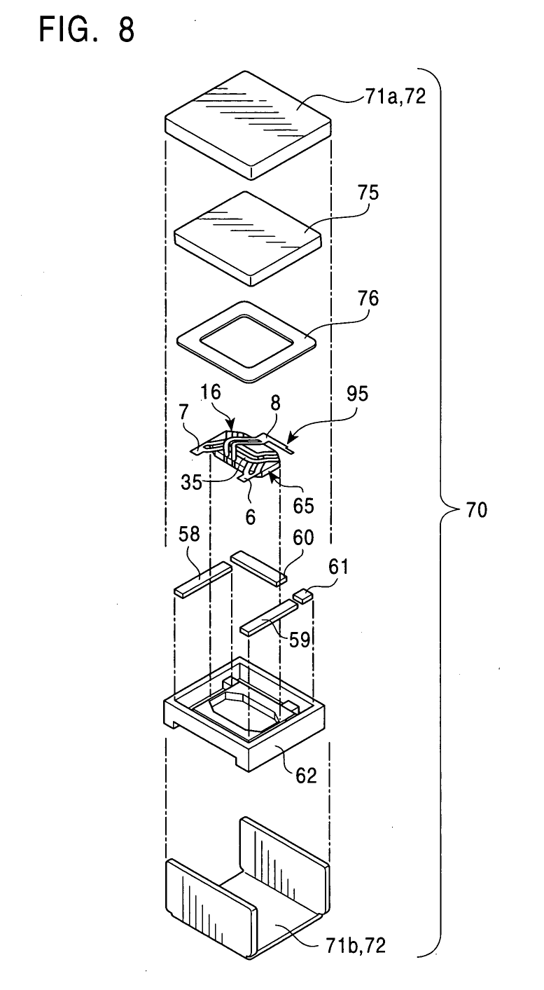

FIG. 8 shows a second embodiment in which a non-reciprocal circuit element according to the present invention is used as an isolator. An isolator 70 of this embodiment is formed in such a manner that, inside a hollow yoke 72 formed of an upper yoke 71a and a lower yoke 71b, in other words, between an upper yoke 71a and a lower yoke 71b, a magnet member 75 formed of a permanent magnet in the shape of a rectangular plate, a spacer member 76, a magnetic assembly 95, matching capacitors 58, 59, and 60, a termination resistor 61, and a resin case 62 for housing the above are housed.

A magnetic assembly 95 is formed in such a manner that the electrode section 16 equivalent to that of the first embodiment is wound around the plate-shaped magnetic member 65 nearly in the shape of a rectangle in plan view. This plate-shaped magnetic member 65 has nearly the same shape as that of the plate-shaped magnetic member 5, which extends horizontally, but it is in the shape of a rectangular plate which is slightly closer to a square shape.

In the electrode section 16 wound around the plate-shaped magnetic member 65, the front-end conductor of the first line conductor 6 is electrically connected to the electrode section (not shown) formed at one end portion on one side of the matching capacitor 59, the front-end conductor of the second line conductor 7 is electrically connected to the electrode section (not shown) formed at the other end portion of the matching capacitor 58, and the front-end conductor of the third center conductor 8 is electrically connected to the matching capacitor 60 and the termination resistor 61, and the matching capacitors 58, 59, and 60 and the termination resistor 61 are connected to the magnetic assembly 65.

Also, in the isolator 70 having the configuration shown in FIG. 7, advantages equivalent to those of the isolator 1 of the above-described embodiment can be obtained.

(Third Embodiment)

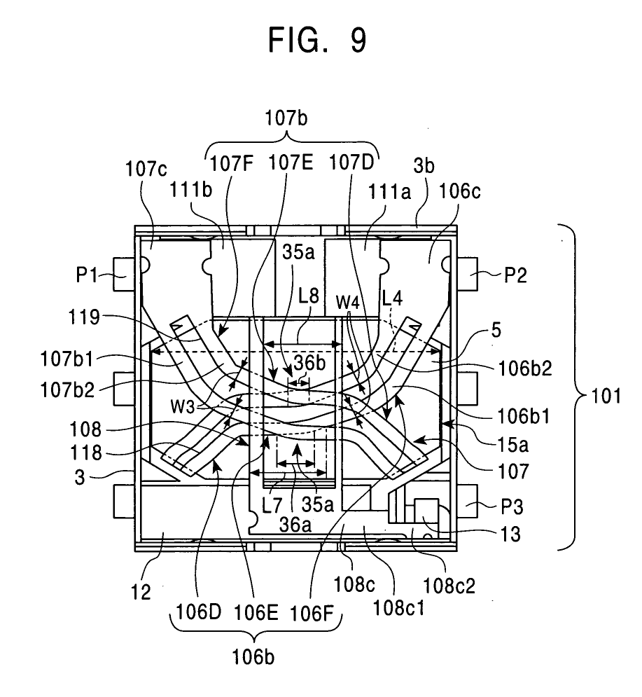

FIG. 9 is a plan view showing a third embodiment in which the non-reciprocal circuit element according to the present invention is used as an isolator.

The particular differences of an isolator 101 of the third embodiment from the isolator 1 of the first embodiment shown in FIG. 1A to FIG. 4 are the shape of the electrode section provided in the magnetic assembly, and the fact that the first and second line conductors are connected to different capacitors.

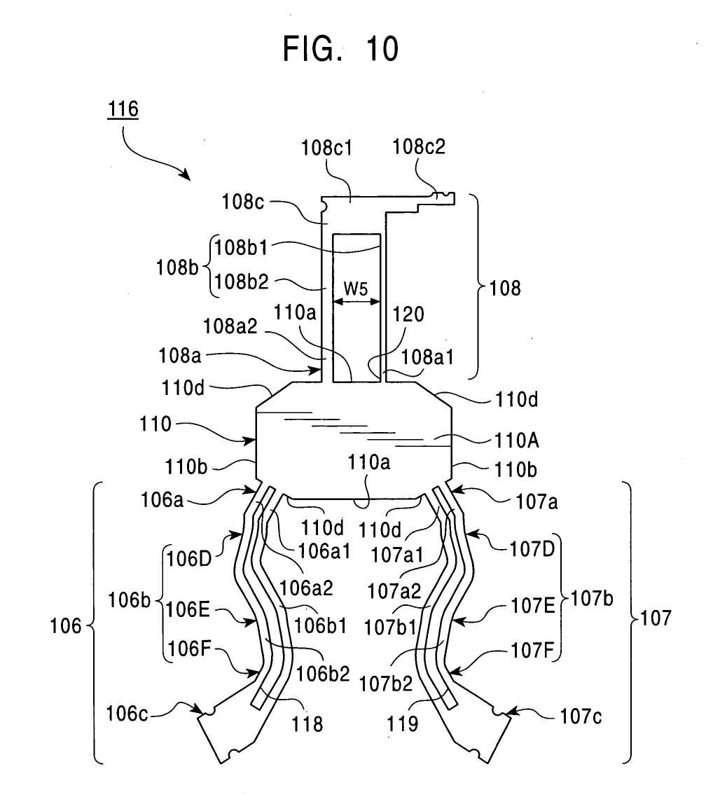

FIG. 10 is a development view of the electrode section 116 of the magnetic assembly 15a provided in the isolator 101 of this embodiment.

This electrode section 116 is formed in such a manner that three line conductors 106, 107, and 108, and the common electrode 110 are formed integrally.

This common electrode 110 is formed of a main-unit section 110A made from a metal plate in a shape which is almost the same as the plate-shaped magnetic member 5 in plan view. That is, the main-unit section 110A is formed nearly rectangular in plan view, which includes two mutually opposing longer-side portions 110a and 110a, shorter-side portions 110b and 110b at right angles to these longer-side portions 110a and 110a, and inclined sections 110d which are positioned at the end portions on both sides of the four longer-side portions 110a and 110a, which are inclined at an angle of 150° with respect to each longer-side portion 110a and which are connected to the shorter-side portion 110b at an inclination angle of 130°.

Then, the first line conductor 106 and the second line conductor 107 are formed to extend from the two inclined sections 110d of one of the longer-side portions among the inclined sections 110d of the four corner portions of the common electrode.

First, from one of the two inclined sections 110d, the first line conductor 106 formed of a first base conductor 106a, a first center conductor 106b, and a first front-end conductor 106c is formed to extend, whereas, from the other inclined section 10d, a second line conductor 107 formed of a second base conductor 107a, a second center conductor 107b, and a second front-end conductor 107c is formed to extend.

The first center conductor 106b is in a wave shape or in the shape of zigzag in plan view, and is formed of three portions, that is, an end portion 106D of the base on the conductor side, an end portion 106F of the front end on the conductor side, and a central portion 106E. The particular difference of this first center conductor 106b from the first center conductor 6b of the first embodiment is that the shape of the central portion 106E is in the shape of the character < in plan view.

The second center conductor 107b also has a shape similar to that of the first center conductor 106b, and is formed of three portions, that is, an end portion 107D of the base on the conductor side, an end portion 107F of the front end on the conductor side, and a central portion 107E therebetween in the shape of the character < in plan view.

Next, in the central portion of the first line conductor 106 along the width direction, similarly to the first embodiment, a slit section 118 is formed, and as a result of forming this slit section 118, the center conductor 106b is divided into two divided conductors 106b1 and 106b2, and the base conductor 106a is also divided into two divided conductors 106a1 and 106a2.

Also, in the central portion of the second line conductor 107 along the width direction, a slit section 119 similar to the slit section 118 is formed, and as a result of forming this slit section 119, a center conductor 107b is divided into two divided conductors 107b1 and 107b2, and the base conductor 107a is also divided into two divided conductors 107a1 and 107a2.

Regarding the width of the slit sections 118 and 119, the width in the central portions 106E and 107E and the end portions 106F and 107F of the front end on the conductor side is formed greater than the width in the end portions 106D and 107D of the base on the conductor side of the first and second center conductors 106b and 107b. That is, the width of the slits 118 and 119 at the intersection portion of the first and second center conductors 106b and 107b is formed larger than the width other than that at the intersection portion. As a result of being in such a size relationship of the slit width, it becomes possible to appropriately set impedance matching with the power amplifier 45 without deteriorating the isolator characteristics.

Furthermore, the width of the divided conductors 106b1 and 106b2 of the first center conductor 106b is formed narrower than the width of the divided conductors 107b1 and 107b2 of the second center conductor 107b. As a result, defective impedance matching with the power amplifier 45, caused as a result of the first center conductor 106b being wound in closer proximity with the magnetic substrate 5 than the second center conductor 107b can be prevented, and appropriate impedance matching can be achieved.

As shown in FIGS. 9 and 10, the conductor width W3 (the conductor width of the first center conductor) of the divided conductors 106b1 and 106b2 which form the first center conductor is preferably less than 150 μm, and more preferably, in the range from equal to or greater than 90 μm to equal to or smaller than 130 μm. Similarly, the conductor width W4 (the conductor width of the second center conductor) of the divided conductors 107b1 and 107b2 which form the second center conductor is preferably less than 150 μm, and more preferably, in the range from equal to or greater than 90 to equal to or smaller than 130 μm.

Similarly to the case of the first embodiment, as a result of the conductor width of the first and second center conductors 106b and 107b being set within above-mentioned range, insertion loss can be reduced further. If the conductor width of the first and second center conductors 106b and 107b is 150 μm or more, the insertion loss becomes high, and this is not desirable. The narrower the conductor width of the center conductors 106b and 107b, the smaller the insertion loss. However, if the conductor width becomes narrower, the strength of the center conductors 106b and 107b themselves is decreased, the workability becomes poor, and the manufacture of the magnetic assembly 15a becomes difficult, which is undesirable. Therefore, from the viewpoint of workability, the limit of the conductor width of the center conductors 106b and 107b is set at 90 μm. However, the limit is not limited to this value, and if the conductor width can be made narrower as the manufacturing technology is improved, the limit can be decreased further.

On the other hand, in the central portion of the other longer-side portion 110a of the common electrode 110, a third line conductor 108 is formed to extend. This third line conductor 108 is formed of a third base conductor 108a, a third center conductor 108b, and a third front-end conductor 108c, which are protrusively formed from the common electrode 110. The third base conductor 108a is formed of two divided conductors 108a1 and 108a2 in the shape of strips, which are formed to extend nearly at right angles from the central portion of the common electrode 110 on the longer side, and a slit 120 is formed between the divided conductors 108a1 and 108a2. One of the divided conductors 108a2 is formed wider than the other divided conductor 108a1.

The particular differences of the third center conductor 108b from the third center conductor 8b of the first embodiment are that the third center conductor 108b is formed of a divided conductors 108b1 nearly in the shape of a line in plan view, which is connected to the divided conductors 108a1 and a divided conductors 108b2 nearly in the shape of lines in plan view, which is connected to the divided conductors 108a2 and that the slit 120 is formed between the divided conductors 108b1 and 108b2. One of the divided conductors 108b2 is formed wider than the divided conductors 108b1.

In addition, the front-end portions of the divided conductors 108b1 and 108b2 are formed integrally with the third front-end conductor 108c in the shape of the letter L. This third front-end conductor 108c is formed of a connection section 108c1 which is formed to extend in the same direction as that of the divided conductors 108a1 and 108a2 by integrally forming the divided conductors 108b1 and 108b2, and a connection section 108c2 which is formed to extend nearly at right angles to the connection section 108c1.

If the two divided conductors of the third center conductor 108b are each nearly in the shape of lines in plan view in the manner described above, when the third line conductor 108 is wound around the plate-shaped magnetic member 5 in order to assemble the magnetic assembly 15a, a positional variation of the third line conductor 108 is not likely to occur.

Furthermore, in a case where the third center conductor 108b is divided into two divided conductors in the manner described above, a wider spacing W5 between the divided conductors 108b1 and 108b2 makes it possible to achieve a wider isolation bandwidth.

Furthermore, in this embodiment, since one of the two divided conductors 108b1 and 108b2 of the third center conductor 108b is made wider than the other in order to increase rigidity, when the third line conductor 108 is wound around the plate-shaped magnetic member 5 in order to assemble the magnetic assembly 15a, the third line conductor 108 can be prevented from being deformed. Furthermore, as a result of the width of one of the divided conductors 108b1 and 108b2 being made narrower, the insertion loss can be maintained low. Therefore, as in this embodiment, as a result of the width of one of the divided conductors 108b2 being made wider and the width of the other divided conductors 108b1 being made narrower, the rigidity of the third center conductor 108b can be increased, and the insertion loss can be reduced.

In the electrode section 116 constructed as described above, the main-unit section 110A of the common electrode 110 is provided along the reverse surface (one side) of the plate-shaped magnetic member 5, the first line conductor 106, the second line conductor 107, and the third line conductor 108 are bent on the obverse surface (the other side) of the plate-shaped magnetic member 5 so as to be attached to the plate-shaped magnetic member 5. The electrode section 116, together with the plate-shaped magnetic member 5, forms the magnetic assembly 15a.

Since the first and second center conductors 106b and 107b are configured as described above, if these are provided along the obverse surface (the other side) of the plate-shaped magnetic member 5, the first and second center conductors 106b and 107b intersect each other on the obverse surface of the plate-shaped magnetic member 5. FIG. 9 shows a case in which the central portions 106E and 107E overlap each other.

In this embodiment, the length of the overlapping portions of the first and second center conductors 106b and 107b at the intersection portion 35a of the two center conductors is, as shown in FIG. 9, a length L7 of the overlapping portions of one of the divided conductors 106b1 of the central portion 106E and one of the divided conductors 107b1 of the central portion 107E, or a length L8 of the overlapping portions of the other divided conductor 106b2 of the central portion 106E and the other divided conductor 107b2 of the central portion 107E. In this case, the lengths L7 and L8 of the overlapping portions of the two divided conductors are each preferably 10% or more of the length L4 of the overlapping portions of the center conductors on the obverse surface (the other side) of the plate-shaped magnetic member 5 for the above-described reasons. More preferably, the lengths L7 and L8 of the overlapping portions is 20% or more of the length L4 of the overlapping portions of the center conductor on the obverse surface (the other side) for the above-described reasons.

The overlapping portions of the divided conductors 106b1 and the divided conductors 107b1 have a non-parallel portion in addition to a parallel portion (a parallel portion 36a), and the overlapping portions of the divided conductors 106b2 and the divided conductors 107b2 also have a non-parallel portion in addition to a parallel portion (a parallel portion 36b). The length of the parallel portion 36a is preferably approximately 20% to approximately 100% of the length L7 of the overlapping portions of the divided conductors, and the length of the parallel portion 36b is preferably approximately 20% to approximately 100% of the length L8 of the overlapping portions of the divided conductors.

If the length of the parallel portion 36a is less than 20% of the length L7 of the overlapping portions of the divided conductors (the ratio of L7 to the length of the parallel portion 36a is less than 20%), the insertion loss increases, and this is not desirable. If the length of the parallel portion 36a is less than 20% of the length L8 of the overlapping portions of the divided conductors (the ratio of L8 to the length of the parallel portion 36b is less than 20%), the insertion loss increases, and this is not desirable.

The intersection angle of the overlapping portions of the two center conductors at the intersection portion 35a of the first and second center conductors 106b and 107b is an intersection angle of the overlapping portions of one of the divided conductors 106b1 of the central portion 106E and one of the divided conductors 107b1 of the central portion 107E, or is an intersection angle of the overlapping portions of the other divided conductor 106b2 of the central portion 106E and the other divided conductor 107b2 of the central portion 107E. The intersection angle in this case is preferably 30 degrees or less, and more preferably, it is 15 degrees or less. In a case where the overlapping portions of the divided conductors have a parallel portion 36a as in this embodiment, preferably, the intersection angle of the two divided conductors at the parallel portion 36a is approximately 0 degrees, and the intersection angle of the two divided conductors at the non-parallel portion is 30° or less. If the intersection angle of the two divided conductors in the non-parallel portion is greater than 30°, the insertion loss is increased, and this is not desirable.

Next, the magnetic assembly 15a is arranged in the central portion of the bottom of the lower yoke 3. On one side of the magnetic assembly 15a on the bottom side of the lower yoke 3, the capacitor substrate 12 is housed, and on the other side thereof, the capacitor substrates 111a and 111b are housed, and on one end side of the capacitor substrate 12, the termination resistor 13 is housed.

Then, the front-end conductor 106c of the first line conductor 106 is electrically connected to the electrode section formed in the capacitor substrate 111a, the front-end conductor 107c of the second line conductor 107 is electrically connected to the electrode section formed in the capacitor substrate 111b, and the front-end conductor 108c of the third center conductor 108 is electrically connected to the substrate 12 and the termination resistor 13. The capacitor substrates 111a, 111b, and 12 and the termination resistor 13 are connected to the magnetic assembly 15a. If the termination resistor 13 is not connected, the isolator functions as a circulator.

At the end portion of the matching capacitor 111b to which a portion of the front-end conductor 107c is connected, a first port P1 of the non-reciprocal circuit element 101 is formed. At the end portion of the matching capacitor 111a to which a portion of the front-end conductor 106c is connected, a second port P2 of the non-reciprocal circuit element 101 is formed. The end portion of the termination resistor 13 to which a portion of the front-end conductor 108c is connected is formed as a third port P3 of the isolator 101.

According to the isolator 101 of this embodiment, in addition to the advantages equivalent to those of the isolator 1 of the first embodiment, the following advantages can be obtained. That is, according to the isolator 101 of this embodiment, since, in addition to the parallel portion, the non-parallel portion exists in the overlapping portions of the two divided conductors, the insertion-loss reduction effect of the isolator can be increased further, and also, there is an improved isolation effect, that is, the isolation bandwidth can be increased further.

(Additional Embodiments)

The present invention will now be described in more detail with reference to embodiments. However, the following embodiments do not limit the present invention.

### EXPERIMENTAL EXAMPLE 1

Each of the conductor widths W1 and W2 of the central portions 6E and 7E of the first and second center conductors 6b and 7b was set at 50 to 200 μm, the width of the slit sections 18 and 19 was set at 150 to 300 μm, the length L3 of the overlapping portions of the two center conductors at the intersection portion 35 of the first and second center conductors 6b and 7b was set at 50% of the length of each of the center conductors 6b and 7b at the other side of the plate-shaped magnetic member 5, and the intersection angle at the intersection portion of the first and second center conductors 6b and 7b was set at 0 degrees. Under these conditions, various types of isolators were produced in a manner similar to FIGS. 1 to 3.

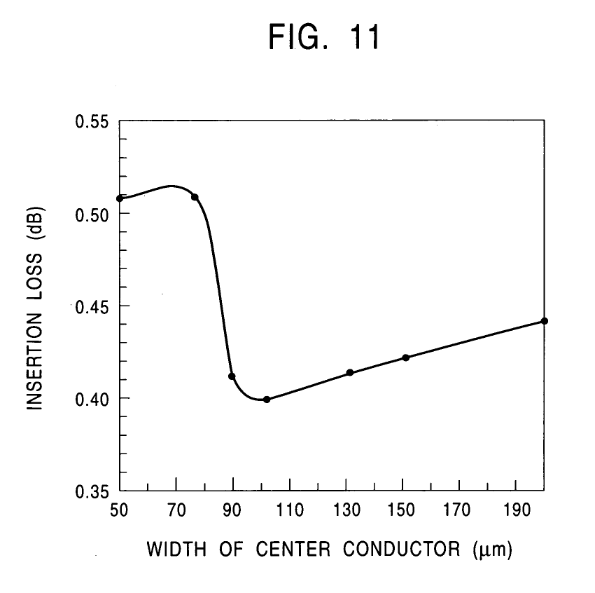

For the obtained isolator, the insertion loss was measured. FIG. 11 shows relationship between the insertion loss and the conductor width of each center conductor.

As shown in FIG. 11, it can be seen that the insertion loss sharply decreases after the vicinity where the conductor width becomes greater than 70 μm, the insertion loss is minimized when the conductor width is 100 μm, and the insertion loss gradually increases after the conductor width becomes greater than 100 μm. More specifically, it can be seen that the insertion loss became 0.42 dB or less when the conductor width is in the range of less than 150 μm, the insertion loss became 0.42 dB or less when the conductor width is in the range of 90 to 130 μm, and the insertion loss became 0.4 dB when conductor width is 100 μm.

The reason why the insertion loss was increased when the conductor width is less than 90 μm is because, since the conductor width was too small, the workability of the center conductor was decreased, and the assembly accuracy of the center conductor with respect to the plate-shaped magnetic member was decreased.

### EXPERIMENTAL EXAMPLE 2

Each of the conductor widths W1 and W2 of the central portions 6E and 7E of the first and second center conductors 6b and 7b was set at 100 μm, the width of the slit sections 18 and 19 was set at 100 μm, the length L3 of the overlapping portions of the two center conductors at the intersection portion 35 of the first and second center conductors 6b and 7b was set at 55% of the length L4 of each of the center conductors 6b and 7b on the other side of the plate-shaped magnetic member 5, and the intersection angle at the intersection portion of the first and second center conductors 6b and 7b was set at 0 degrees. Under these conditions, similarly to FIGS. 1 to 3, the isolator of the first embodiment was produced.

The isolator of the comparative example 1 was produced in a manner similar to the first embodiment except that each of the conductor widths W1 and W2 of the central portions 6E and 7E of the first and second center conductors 6b and 7b was set at 150 μm.

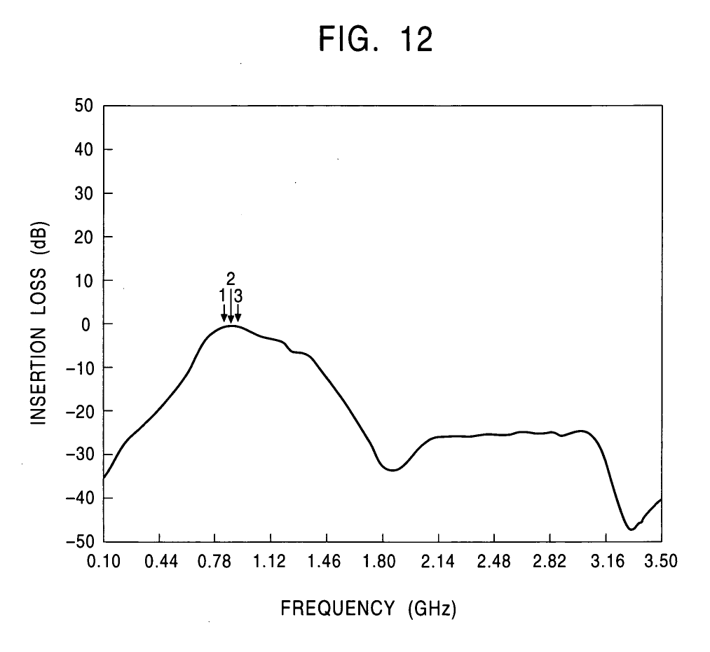

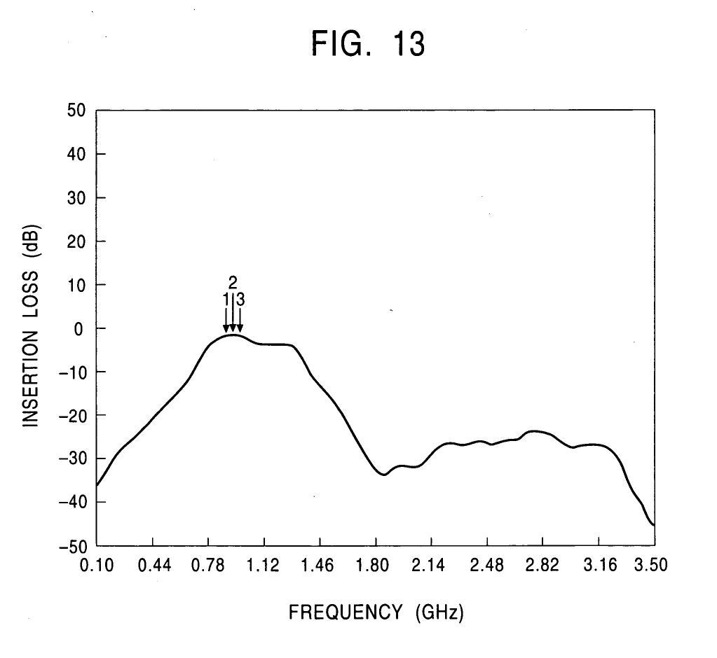

For the isolator of the first embodiment and comparative example 1, the dependence of the insertion loss on frequency was measured. The results are shown in FIGS. 12 and 13. The actually measured values of the frequency and the insertion loss in the vicinity of the peak of the insertion loss is shown in Table 1. The downward arrows 1 to 3 shown in FIGS. 12 and 13 correspond to measurement points 1 to 3 in Table 1.

TABLE 1

| | First Embodiment | | Comparative Example 1 | |
|---|---|---|---|---|
| Measurement | Frequency | Insertion | Frequency | Insertion |
| Point | (MHz) | Loss (dB) | (MHz) | Loss (dB) |
| 1 | 838.5 | 0.60 | 882.5 | 0.65 |
| 2 | 872.0 | 0.47 | 916.0 | 0.52 |
| 3 | 905.5 | 0.60 | 946.5 | 0.63 |

The comparison of the results of the first embodiment and comparative example 1 shows that, as shown in FIGS. 12 and 13, in the first embodiment and comparative example 1, the peak width (near the arrows 1 to 3) of the peak of the insertion loss of approximately the same degree of width, and the frequency bandwidth of the insertion loss is almost the same. This is because the ratio of the length L3 of the overlapping portions to L4 is almost the same in the first embodiment and comparative example 1. On the other hand, as shown in Table 1, the insertion loss is lower on the whole in the first embodiment. This is because the conductor width (100 μm) of the first and second center conductors of the first embodiment is narrower than the conductor width (150 μm) of the first and second center conductors of comparative example 1.

Therefore, in order to decrease the insertion loss, the conductor width of the center conductor should be decreased as much as possible.

What is claimed is:

1. A non-reciprocal circuit element comprising:
a plate-shaped magnetic member;
a common electrode arranged on one side of the plate-shaped magnetic member;
first, second, and third center conductors which extend in three directions from the outer peripheral portion of the common electrode in such a manner as to surround said plate-shaped magnetic member, which are bent on the other side of the plate-shaped magnetic member, and which intersect one another at predetermined angles on the other side; and
a bias magnet arranged in such a manner as to oppose said plate-shaped magnetic member,
wherein the conductor width of at least portions of said first and second center conductors is less than 150 μm.

2. A non-reciprocal circuit element according to claim 1, wherein the conductor width of at least portions of said first and second center conductors is equal to or greater than 90 μm to equal to or smaller than 130 μm.

3. A non-reciprocal circuit element according to claim 1, wherein the length of the overlapping portions of the two center conductors at the intersection portion of said first and second center conductors is equal to or greater than 10% of the length of each center conductor at the other side of said plate-shaped magnetic member.

4. A non-reciprocal circuit element according to claim 1, wherein the length of the overlapping portions of the two center conductors at the intersection portion of said first and second center conductors is equal to or greater than 20% of the length of each center conductor at the other side of said plate-shaped magnetic member.

5. A non-reciprocal circuit element according to claim 1, wherein the intersection angle at the intersection portion of said first and second center conductors is equal to or less than 30 degrees.

6. A non-reciprocal circuit element according to claim 1, wherein the intersection angle at the intersection portion of said first and second center conductors is equal to or less than 15 degrees.

7. A non-reciprocal circuit element according to claim 1, wherein said first and second center conductors at said overlapping portions are arranged nearly in parallel with each other.

8. A non-reciprocal circuit element according to claim 1, wherein a slit section along the length direction of each center conductor is provided in the central portion of each of said first and second center conductors in the width direction, and two divided conductors are provided in each of said center conductors by the slit section.

9. A non-reciprocal circuit element according to claim 1, wherein a matching capacitor is connected to each of said first and second center conductors, and a matching capacitor and a termination resistor are connected to said third center conductor.

10. A communication device comprising:
a non-reciprocal circuit element according to one of claims 1 to 9;
a transmitting circuit section connected to one of said first and said second center conductors of the non-reciprocal circuit element; and
an antenna connected to the other one of said first and second center conductors.
